(19) United States
(12) Patent Application Publication
(10) Pub. No.: US 2017/0191601 A1
(43) Pub. Date: Jul. 6, 2017

(54) Pipeline Inspection Device

(71) Applicant: Veysel Firat Sever, Columbus, OH (US)

(72) Inventor: Veysel Firat Sever, Columbus, OH (US)

(21) Appl. No.: 14/987,713

(22) Filed: Jan. 4, 2016

(51) Int. Cl. F16L 55/32; G01N 29/22

(52) U.S. Cl. CPC F16L 55/32; G01N 29/225

(57) ABSTRACT

The present invention relates to a robotic pipeline inspection device that measures the residual strength of the pipe. Aging underground infrastructure is a major problem around the globe. There is a need for a deterministic, non-destructive, pipeline condition assessment device. Some of the other internal pipeline inspection devices work well, but the data obtained by using them is limited to thickness of the pipe or internal video of the pipeline. The invention presented herein can send and receive ultrasonic pulse into the pipe wall within millimeters, thereby, determining the residual strength of the pipe material. The embodiment of the present invention provides a pipeline inspection device comprising: a body comprising mounted wheels; a transducer and receiver connected to the body; at least one motor to power the wheels and the transducer and receiver; and wiring that connects the transducer and receiver to the at least one motor.

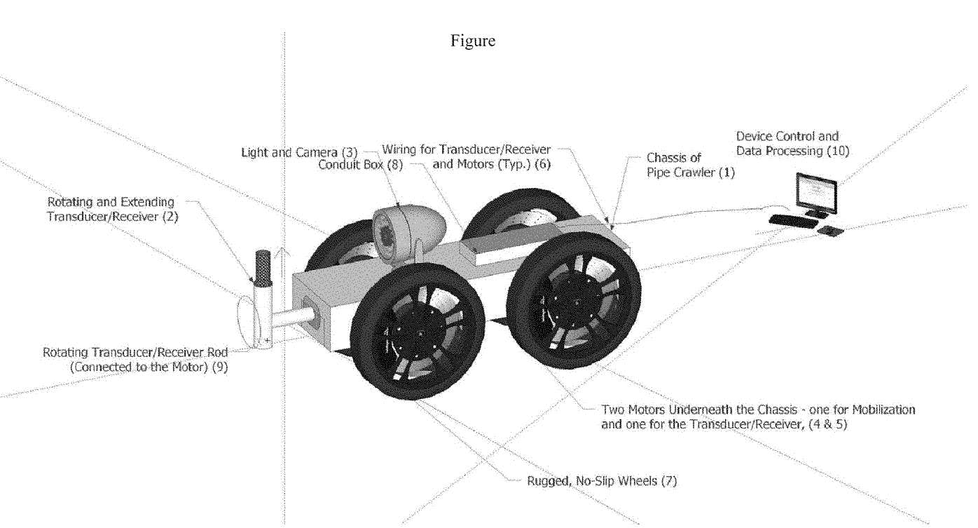

### BACKGROUND OF THE INVENTION

The present invention relates to a pipeline inspection device and, more particularly, to a robotic device that measures the residual strength of the pipe.

Aging underground infrastructure is a major problem in North America and around the globe. There is a need for a deterministic, non-destructive, pipeline condition assessment device. Some of the other internal pipeline inspection devices work well, but the data obtained by using them is limited to thickness of the pipe or internal video of the pipeline. The other devices do not have the ability to send and receive ultrasonic pulse into the pipe wall within millimeters, thereby, residual strength of the pipe material cannot be determined with the available devices on the market. As can be seen, there is a need for a device that determines residual strength of pipe material.

### BRIEF DESCRIPTION OF THE DRAWINGS

The FIGURE is a perspective view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a pipeline inspection device comprising: a body comprising mounted wheels; a transducer and receiver connected to the body; at least one motor to power the wheels and the transducer and receiver; and wiring that connects the transducer and receiver to the at least one motor.

The present invention may include an ultrasonic (echo-pulse) remote controlled, pipeline condition assessment device. The device of the present invention may be a robotic, remote controlled pipe crawler that may travel along a pipeline and retrieve data on pipe's condition by sending and receiving ultrasonic signals. The data may be transmitted to a computer and processed to make a correlation between the ultrasonic pulse characteristics and pipe residual strength (modulus of elasticity and thickness).

The present invention may include a rotating and extending transducer/receiver mounted at the front of the remote controlled, “pipe crawler” which may enable a user to measure the residual strength (stiffness) of the pipe material by non-destructive and no-dig means from the inside of a pipeline.

Referring now to FIGURE, the present invention may include a body 1 of the device on which all the other elements may be mounted. A rotating and extending transducer/receiver 2 may be mounted to the rotating transducer/receiver rod 9, which may extend from the front of the body 1. A conduit box 8 may be attached to the body to contain the wiring 6. The transducer/receiver 2 may receive ultrasonic signals and send them to a signal conditioning unit 10 via the conduit box 8 and 6. A light and camera 3 may be mounted to the body 1 and may be used for lighting and recording video. The light and camera 3 may be connected to a closed-circuit TV system via the conduit box 8 and 6. The present invention may further include wheels 7, which may be rugged non-slip wheels. The wheels 7 and the transducer/receiver 2 may be connected to a motor 4, 5, such as a motor for spinning of the wheels 7 and a dual motor for the transducer 2 rotations and extension. The wiring 6 may connect to the other components and power the device.

The device may include a car that may travel along a pipeline, a rotating and extending transducer/receiver, a light and camera assembly, mechanical gear (motors), electrical gear (wiring), and data conditioning unit (computer and software). The pipe crawler (car) may include two motors—one for mobilization of the whole device and the other dual motor for rotating and extending the transducer/receiver. The remote controlled assembly may be inserted into a pipeline through manholes, valves, or access pits. Then the ultrasonic transducer/receiver may be extended to move close enough to the pipe interior wall to send/receive accurate ultrasonic signals to and from the pipe interior wall. Then the transducer/receiver may be rotated to acquire ultrasonic measurements along interior circumference of the pipe at predetermined intervals (e.g. every 30 degrees). Once ultrasonic measurements are completed at one location then the assembly may be moved forward along the pipe to obtain measurements at the next stop. Each measurement location along the pipe may also be determined prior to inspection (for example, every 10 feet/3 meters). Upon completion of inspection of a pipeline a pipe condition profile (with color coding, for example red for poor, yellow for moderate, and green for sound condition) using the computer and a simple software program to be developed for the present invention. The pipe condition profile may be created based on ultrasonic measurements made at each measurement location.

The present invention may be made by the following method. A robotic pipe crawler, similar to those used for closed-circuit-tv inspection of pipelines, may be used. An extending/rotating ultrasonic transducer/receiver, the motors, wiring may be installed. The crawler and transducer/receiver may be connected to a control room with a computer and robotic crawler control equipment (available for CCTV inspection of pipelines). In certain embodiments, the transducer/receiver and camera/light may be placed on the different spots of chassis. The present invention may be used for deterministic condition assessment of small diameter pipelines that are used in a number of industries including water, wastewater, and oil/gas.

It should be understood, of course, that the foregoing relates to exemplary embodiments of the invention and that modifications may be made without departing from the spirit and scope of the invention as set forth in the following claims.

What is claimed is:

1. A pipeline inspection device comprising:
a body comprising mounted wheels;
a transducer and receiver connected to the body;
at least one motor to power the wheels and the transducer and receiver;
a control unit, signal processing unit and software; and
wiring that connects the transducer and receiver to the at least one motor and to the control unit.
